(19) United States
(12) Patent Application Publication
(10) Pub. No.: US 2013/0290637 A1
(43) Pub. Date: Oct. 31, 2013

(54) PER PROCESSOR BUS ACCESS CONTROL IN A MULTI-PROCESSOR CPU

(71) Applicants: Flaviu Dorin Turean, Mountain View, CA (US); Stephane Rodgers, San Diego, CA (US); George Harms, San Jose, CA (US); Joshua Stults, Irvine, CA (US)

(72) Inventors: Flaviu Dorin Turean, Mountain View, CA (US); Stephane Rodgers, San Diego, CA (US); George Harms, San Jose, CA (US); Joshua Stults, Irvine, CA (US)

(73) Assignee: BROADCOM CORPORATION, Irvine, CA (US)

(21) Appl. No.: 13/460,689

(22) Filed: Apr. 30, 2012

(51) Int. Cl. G06F 12/08

(52) U.S. Cl. 711/122; 711/130; 711/E12.038; 711/E12.024

(57) ABSTRACT

A technique to provide hardware protection for bus accesses for a processor in a multiple processor environment where at least two zones are established to separate or segregate processor functionality. In one implementation, control registers within a cache memory that supports the multiple processors are loaded with addresses associated with access rights for a particular processor. Then, when an access request is generated, the registers are checked to authorize the access.

### CROSS-REFERENCE TO RELATED APPLICATION

This application is related to U.S. patent application titled “Tracking ownership of data assets in a multi-processor system” (Docket No. BP24375), having application Ser. No. ______ and a filing date of ______.

### BACKGROUND OF THE INVENTION

1. Technical Field of the Invention

The embodiments of the invention relate to processing systems and, more particularly, to systems having multiple processors or processing cores.

2. Description of Related Art

In today's highly technology oriented environment, processing systems are implemented in just about any device that provides data manipulation or user interaction. More familiar devices that implement a processor include personal computers, laptop computers, tablet computers, servers, mobile phones, gaming consoles, televisions, digital video recorders and players, set-top boxes, instrumentation, communication devices and appliances. These are just examples and are not inclusive of devices that implement processing units or systems.

In many devices, the processing unit may have multiple processors or processing cores in order to provide higher performance and/or multi-tasking. In some of these multi-processor systems, when multiple applications or programs are running, access control is typically needed to separate the functionality of the applications running on multiple processors. Separation or segregation of different applications and/or tasks running on different processors ensures that one application does not interfere with the execution of another. Likewise data assigned to one processor should not be accessed by another processor, unless that data is shared between the two processors. Therefore, one aspect of this separation is the controlling of bus accesses each application may make to the rest of the system.

Typical bus access control in a CPU (Central Processing Unit), whether single or multiple processors, is performed by a system Memory Management Unit (MMU) under control of an Operating System (OS) software. Because the MMU relies on software and the OS, subversion in the programming or bugs in the system may lead to unintended bus access control, which could lead to an access violation across the separation zone.

For example, in a multi-processor system, in which one processor environment provides trusted or secure operations while another operates in an unsecure or restricted environment, there is a substantial possibility of an incursion from the unsecure zone into the secure zone, when the OS is managing the separation. For example, in a set-top box that allows a user to receive television signals and also allows the user to access the Internet, the secure environment may run applications pertaining to the reception and displaying of certain channels provided by a cable or satellite provider. The unsecure environment in the set-top box may be the applications that allow a user to access the Internet for web browsing, gaming, etc. In this example, the content provider (e.g. cable or satellite provider) would not want the user or anyone else to access the applications pertaining to the channels. However, if there is commonality in software that controls the accesses to both environments, such as running the same OS to manage accesses in both environments, then there is a higher risk of a violation. Thus, such a violation, whether intentional or non intentional, could result in an unsecure breach into the secure applications of the set-top box, such as a web-induced breech into the television channels.

Accordingly, there is a need to obtain a much more efficient way to provide a separation of processor environments which does not rely strictly on the system OS.

### BRIEF DESCRIPTION OF THE DRAWINGS

FIG. 1 is a schematic block diagram showing a multi-processor system in which bus access control on the processors is provided by hardware controls in a secondary cache in accordance with one embodiment for practicing the present invention.

FIG. 2 is a schematic block diagram showing a more detailed multi-processor system in which bus access control on the processors is provided by control registers in a secondary cache in accordance with one embodiment for practicing the present invention.

FIG. 3 is a diagram showing one example implementation for the control registers of FIG. 2 in accordance with one embodiment for practicing the present invention.

FIG. 4 is a diagram showing memory space mapping assigned to the control registers of FIG. 3 in accordance with one embodiment for practicing the present invention.

FIG. 5 is a diagram showing memory space mapping assigned to the control registers of FIG. 3, in which some portions of the memory space is allocated as shared space, in accordance with one embodiment for practicing the present invention.

FIGS. 6A and B show a schematic block diagram which is a more detailed multi-processor system to the system shown in FIG. 2 as one embodiment for implementing the system of FIG. 2.

FIG. 7 is a diagram showing one example of a cache tag having access rights flag bits appended thereon, which access rights flag bits are associated with data stored in the secondary cache to indicate ownership in accordance with one embodiment for practicing the present invention.

FIG. 8 is a diagram showing an alternative example of data having access rights flag bits appended thereon, which access rights flag bits are used to indicate ownership in accordance with one embodiment for practicing the present invention.

FIG. 9 is a flow chart showing a method for performing access checks when an access request is generated by one of the processors in a multi-processor system in loading a cache line in accordance with one embodiment for practicing the present invention.

### DETAILED DESCRIPTION OF THE INVENTION

The embodiments of the present invention may be practiced in a variety of computing circuits, devices and/or systems that utilize multiple processors, processing cores and/or processing circuits. The illustrations herein describe a processing module, a processor or a CPU (e.g. CPU1, CPU2) for a device that provides a processing function in the described embodiments. However, it is appreciated that a variety of other devices and/or nomenclature may be used in other embodiments to provide for the processing function in practicing the invention. Furthermore, the particular example embodiments implement the hardware controls for bus access in a secondary (or L2) cache. In other embodiments, other levels of cache may implement the invention to control bus access. The invention may be readily adapted to other usages where multiple processing environments (zones, domains, etc.) exist, in which separation and/or segregation between two or more zones is to be implemented.

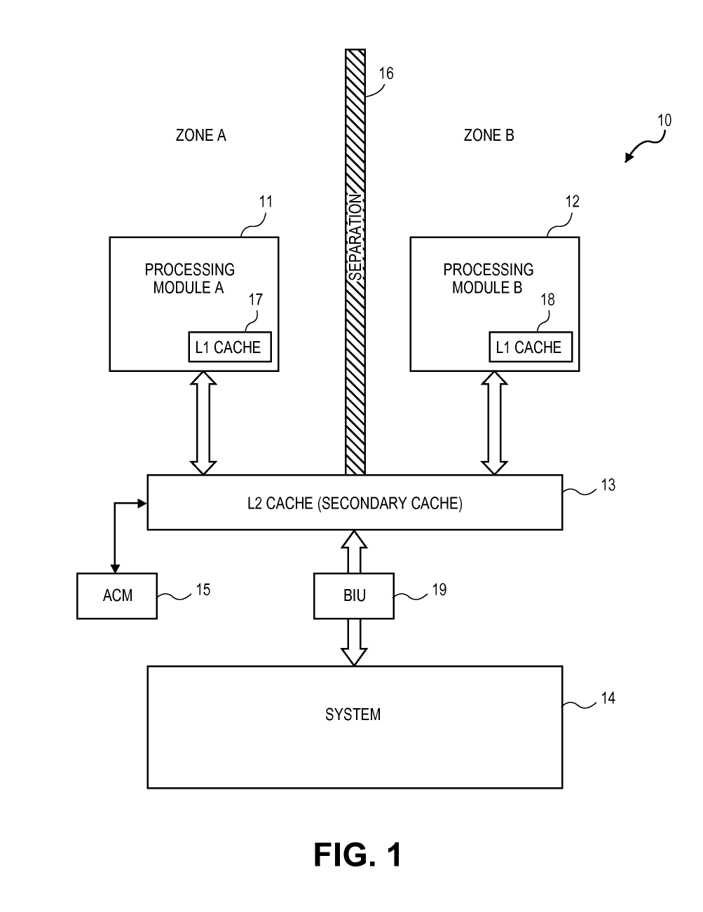

FIG. 1 shows a computing system 10 according to one embodiment for practicing the invention. System 10 may be implemented in a device, module, board, etc. One or more components of system 10 may also be implemented on an integrated circuit chip or on multiple integrated circuit chips. System 10 is a multi-processor system having at least two processors. Although two processing modules are shown in FIG. 1, other embodiments may have more than two processing modules or processors. The particular embodiment of FIG. 1 shows system 10 comprised of two processing modules 11 and 12, identified as Processing Module A and Processing Module B, respectively. It is to be noted that the two processing modules 11, 12 may be comprised of various processing devices, circuitry, etc. For example, processing modules 11, 12 may each be comprised of a processor, such as a processor generally known as a Central Processing Unit (CPU). In another example, each processing module 11, 12 may be comprised of different processing cores of a single CPU, or some other processing circuitry. Processing Module A includes a Level 1 (L1) cache 17, which is exclusive to Processing Module A. Likewise, Processing Module B includes a Level 1 (L1) cache 18, which is exclusive to Processing Module B. The L1 caches may also be referred to as primary caches in some instances. The two processing modules 11, 12 are coupled to a Level 2 (L2) cache 13, which is also designated as a secondary cache (SC). The L2 cache or SC 13 provides mutual caching and data coherency to both processing modules 11, 12. In one embodiment, L2 cache is inclusive to both L1 caches 17, 18, meaning that cache lines of L1 cache 17 and L1 cache 18 are also included and stored in SC 13.

SC 13 is coupled to a Bus Interface Unit (BIU) 19, which interfaces SC 13 to a bus that is used for accessing other portions of system 10 (henceforth noted as system portion 14). System portion 14 exemplifies other portions of system 10 that may be accessed by BIU 19 and may include (but not limited to) memory, peripherals, other cache or storage devices, bridges, buses, registers, etc. In one embodiment, system portion 14 is representative of a Random Access Memory (RAM), in which SC 13 communicates with the memory via BIU 19. Generally, Static RAM (SRAM) devices or circuitry is utilized for cache memories, such as SC 13, and Dynamic RAM (DRAM) devices or circuitry is utilized for memory. However, the cache and memory may not be limited to such devices and other devices may be readily used in other embodiments.

In a typical operation, when one of the processing modules 11, 12 generates a request to access system portion 14, a tag address is generated for a hit in its L1 cache. When a cache line miss occurs in the L1 cache, the address tag is passed to SC (or L2 cache) 13 for a hit in SC 13. When a cache line miss occurs in SC 13, SC 13 then accesses system portion 14 corresponding to the address request. When system portion 14 being accessed is a memory, the fetch is a data access pertaining to the memory. Since SC 13 is an inclusive cache, any cache line hit in SC 13 ensures a hit in L1 cache. It is appreciated that general operations of cache memories, including cache line hits and misses, victimizing a cache line, or maintaining cache coherency are known in the art.

When the access is to memory, SC 13 accesses a location in memory via a bus and BIU 19. Generally, when a processing module generates an access request, an address is generated and, typically translated, to provide either a physical address or a virtual address that corresponds to a location in memory. As noted above, the memory may be RAM memory, or it may be other types of memory, including hard disk, flash, etc. Furthermore, although not shown, other components may reside between SC 13 and system portion 14 shown in FIG. 1. For example, system 10 may include a level 3 (L3) cache in some embodiment. Since SC 13 operates as a cache memory to both processing modules 11, 12, the embodiments of the invention described herein uses SC 13 as the control level for ensuring integrity between the two zones.

As shown in FIG. 1, Processing Module A operates in one zone (Zone A) and Processing Module B operates in a second zone (Zone B). Generally, when operating in separate or segregated zones, environments or domains, the two processing modules operate on different applications, so that Processing Module A executes one set of instructions, while Processing Module B executes a different set of instructions. Segregation or separation of this nature are typically referred to as sandboxing or sandbox mode. The purpose of most sandboxing is to prevent one zone from accessing functionality in the other zone or to have controlled access of one zone into another. In some instances, both zones may be limited from having access to the other zone or only have controlled access between zones. In some applications, one zone may be regarded as a secure or trusted zone and the other as a non-secure or non-trusted zone, in which access by the applications operating on the non-secure zone are prevented or controlled from accessing applications running in the secure zone. Accordingly, a functional separation 16 is shown to designate the separation of the two zones. As noted, in some embodiments, one zone may have access to the other zone. In other embodiments, both zones are completely segregated functionally, so that one may not access the other, and vice versa.

As noted in the Background section above, a number of devices utilize multiple processors or processing cores to run separate programs, applications, etc. In a situation where one zone is not to have access to a second zone, one way to ensure this separation is by checking the accesses to the system portion 14. That is, by ensuring accesses that are allocated to the Processing Module A are not accessed by Processing Module B, unless the location of the access is a shared location, applications running on Processing Module B may be prevented from breaching the functional separation 16. One way to achieve this protection is to provide an access check and access control to ensure that the correct processing module is accessing a permitted location for that processing module. Since SC 13 is at the highest common hierarchical level to Processing Module A and Processing Module B, placing the access control at this level ensures that accesses generated below SC 13 fall within the protection.

Also as noted in the Background section above, having the system OS, or other types of operating software, provide the access control is a detriment, since these types of programs may be accessed and readily breached. In order to ensure that software programming is not the base access control for controlling system access from SC 13, embodiments of the invention rely on hardware controls to establish and maintain the bus access control. Accordingly, as shown in FIG. 1, an Access Control Manager (ACM) 15 is used. In one embodiment, ACM 15 is a separate processor from Processing Module A and Processing Module B, and is used to initialize the access control set up in SC 13. As shown, ACM 15 is coupled to SC 13. In other embodiments, ACM 15 may be some other form of hardware, such as a state machine or other dedicated circuitry, which provides the functional separation of the zones as described below.

In operation, when initialized, ACM 15 executes a set-up routine to establish the functional separation of Processing Module A and Processing Module B within SC 13. As described in detail below, ACM 15 sets the locations of system portion 14 that may be accessed by Processing Module A and Processing Module B and this control is established within SC 13. Since all accesses to BIU 19 from Processing Module A and Processing Module B traverses through SC 13, address mapping control within SC 13 ensures the capture of all access requests generated by Processing Module A and Processing Module B. When a particular access request comes from a particular processing module, an access check may be performed within SC 13 to check if that particular processing module has authorization to access the location specified for the particular access request.

Because ACM 15 is a separate processing device from Processing Module A and Processing Module B and because ACM 15 is a dedicated processor or processing device to perform the initialization operation to set the location partition definition in SC 13, the OS is not the main entity setting the zone separation. ACM 15, upon initialization connects with SC 13 to set addresses (or address range) corresponding to locations of system portion 14, which may be accessed by SC 13 for Processing Module A and to set addresses (or address range) corresponding to locations system portion 14 which may be accessed by SC 13 for Processing Module B. This address setting in SC 13 is permitted only by ACM 15 and not permitted by either of the processing modules 11, 12. Once set, any access from Processing Module A or Processing Module B to system portion 14 have the address generated by the requesting processing module checked with the ACM set up addresses in SC 13. If the access check passes, that processing module access is permitted and SC 13 communicates to transfer data between SC 13 and system portion 14. However, when the access check fails, SC 13 is prevented from making the access (such as for data transfer).

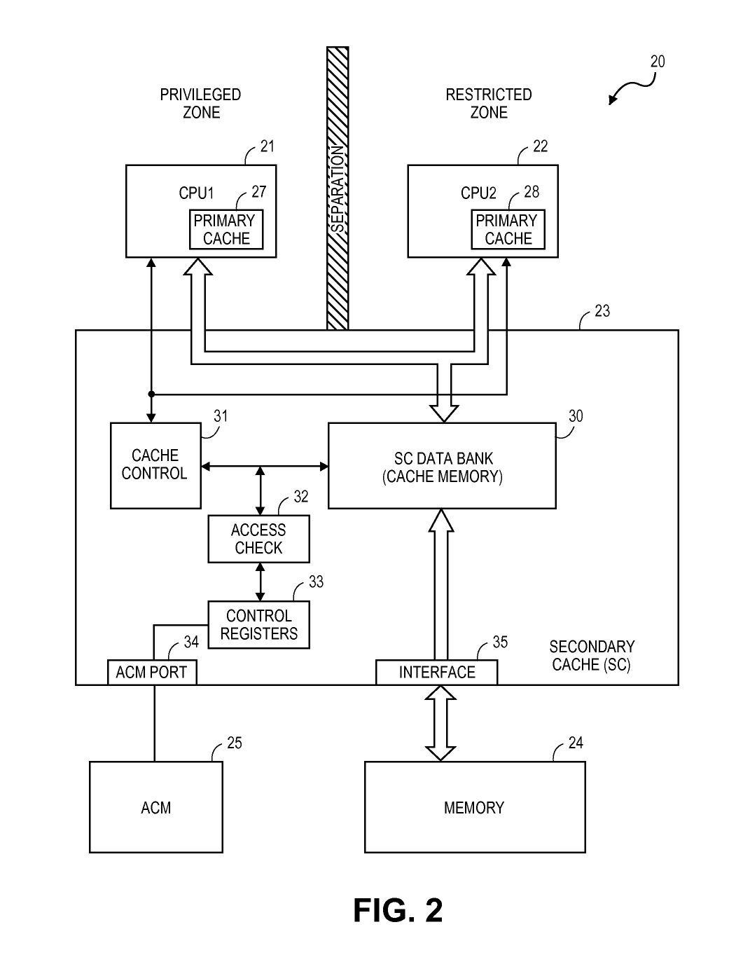

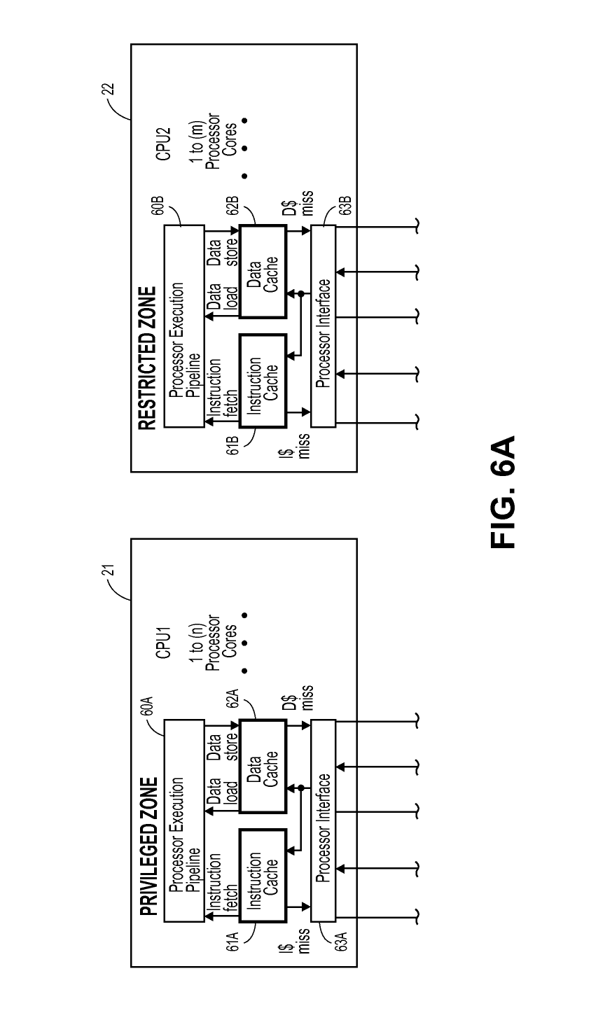

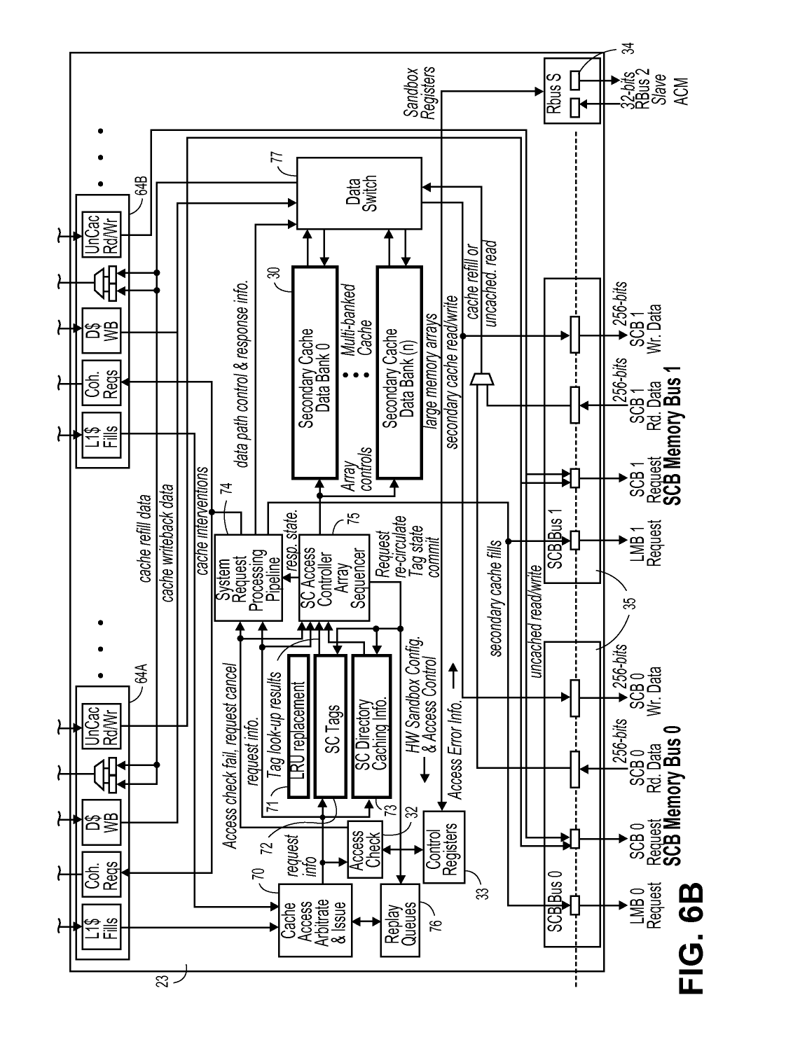

Strictly as an example, in this manner, a set-top box provider may program ACM 15 to reserve certain locations of system portion 14 for use by the Zone A. Processing Module A would provide various secure functions (when Zone A is set up as the secure zone), such as setting the set-top box to receive certain cable or satellite channels. ACM 15 may be used to set the addresses of locations that may be accessed by Processing Module B as well. This is typically done at initialization, such as at turn-on, boot, reset, etc. Once SC 13 is programmed with addresses that are reserved for Processing Module A and Processing Module B, Processing Module B may be loaded with OS programming, applications programming, etc. If for example, the set-top box is to have Internet access capability, Zone B may provide that function. During operation, all accesses to memory generated by Processing Module B are checked with the addresses locations stored in SC 13 to ensure that Processing Module B is permitted access to that location. In this manner, unauthorized access attempts to system portion 14 from a non-secure Zone B (whether by user attempt, entry through public connections, etc.) are caught in SC 13, before such an access is permitted. Furthermore, since only ACM 15 has the ability to change the address set-up in SC 13, other programming attempts through Zone B, OS, applications program, etc. are not successful. More detailed embodiments of system 10 are illustrated in FIGS. 2 and 6. It is to be noted that similar controls may be placed on Zone A as well.

FIG. 2 shows a system 20, which shows a more detailed embodiment for practicing the invention. Processors 21 and 22 are equivalent to processing modules 11 and 12 of FIG. 1, but are denoted as Central Processing Units, CPU1 and CPU2. Zone A of FIG. 1 is noted as a Privileged Zone, while Zone B of FIG. 1 is noted as a Restricted Zone. In one embodiment, the Privileged Zone is equivalent to a secure zone and the Restricted Zone is equivalent to a non-secure zone. Similarly, primary cache 27 and 28, SC 23, ACM 25 are likewise equivalent respectively to L1 cache 17 and 18, SC 13, ACM 15 of FIG. 1. System portion 14 of FIG. 1 is noted as a memory 24 in the particular example illustrated in FIG. 2. However, as noted above, other devices and components, other than memory 24, may be accessed as part of system portion 14 of FIG. 1. Interface 35 provides a bus interface of SC 23 to memory 24.

SC 23 also includes cache control module 31, access check module 32 and control registers 33. SC 23 also includes one or more data banks 30 to store the cached data. When one of the CPUs 21, 22, makes an address access, it first checks its primary cache for a hit. When a miss occurs, the request is passed to cache control module 31 of SC 23. Cache control module translates the address and attempts for a hit in data bank 30. Generally, address tags are compared to determine if data bank 30 contains a valid cache line corresponding to the tag. Cache control module 31 also performs other functions such as maintaining data coherence, victimizing, as well as other functions normally performed for caches. However, beyond normal operations for caches, SC 23 includes control registers 33 and access check module 32 to provide the access check function earlier described in reference to FIG. 1.

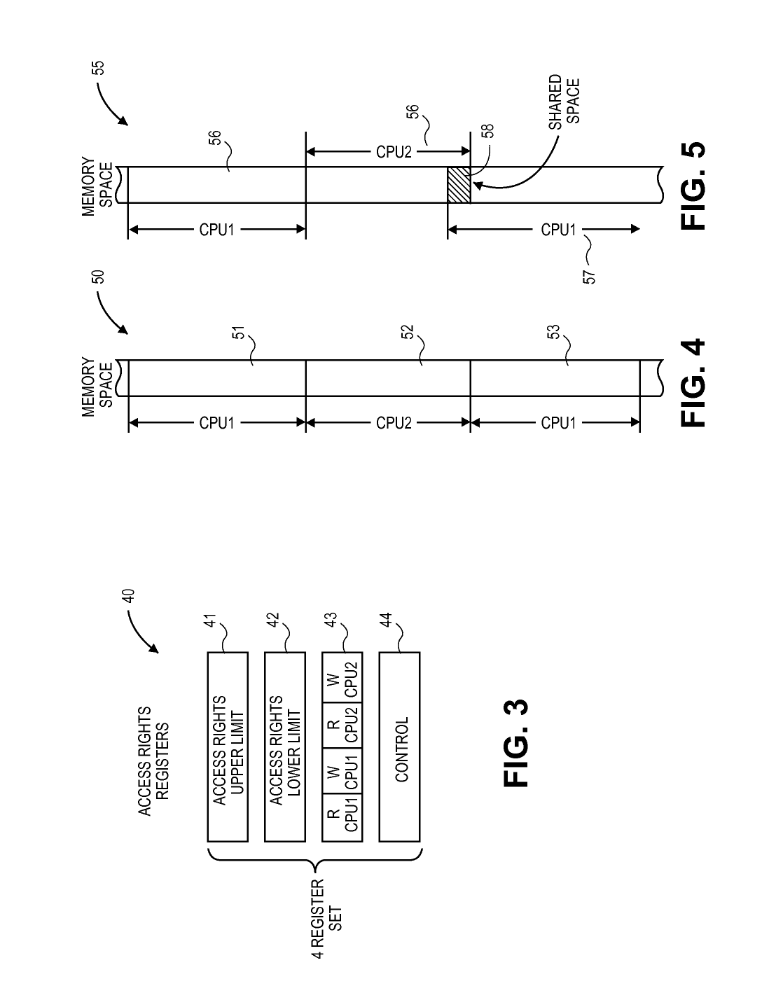

During initialization, ACM 25 programs control registers 33 to define what locations in memory 24 are accessible by each of the CPUs. A variety of control register configurations may be used for control registers 33 to define which locations in memory may be accessed by each CPU. FIG. 3 shows one particular implementation for control registers 33. As shown in FIG. 3, a set of access rights registers 40 are used for configuring an address range that a CPU may access. In one embodiment four registers, designated as registers 41, 42, 43, 44 are used as a set for determining an access range that is mapped to memory 24. Register 41 contains an upper address limit, while register 42 contains a lower address limit. Thus, the values in registers 41 and 42 provide the upper and lower access limits for the register set 40 that corresponds to an address range in memory.

Register 43 contains values that determine which CPU has access to the specified address range determined by registers 41, 42. Register 43 also determines if an allowed access type is a read access and/or a write access to the specified address range. In one embodiment, a bit is set for CPU1 read (R) access right, a bit for CPU1 write (W) access right, a bit for CPU2 read access right and a bit for CPU2 write access right. The bits of register 43 may be set in any combination to determine which CPU may access the address range and which type of access (read and/or write) is permitted. For example, setting only the CPU1 read and CPU1 write access bits would allow SC 23 to permit read and write accesses to the specified range of address locations by CPU1. This would be the instance when CPU1 and CPU2 are sandboxed to separate the two zones, in which CPU2 would be prevented from accessing the specified address range. Register 44 is used to contain values pertaining to various other controls that may be placed on the specified address range defined by registers 41, 42. For example, ReadCheck or WriteCheck operations may be set using values in control register 44.

Control registers 33 may be comprised of a number of such register sets 40. When multiple registers sets 40 are utilized, the memory may be mapped into isolated regions for CPU1 and CPU2. FIG. 4 shows one such example where one register set defines a range of addresses 51 for CPU1, a second register set defines a range of addresses 52 for CPU2 and a third register set defines a range of addresses 53 for CPU1. Accordingly, memory space mapping 50 shows how sections of memory may be mapped for CPU1 access or CPU2 access. Note that with the bit values available in register 43, each of the memory regions may be mapped for read only, write only or both read and write.

It is to be noted that a plurality of register sets provide for a plurality of mapping regions. In one embodiment, eight register sets 40 are used to define eight mapping regions of the memory. In another embodiment, memory 24 is pre-mapped into eight distinct regions and a register set is assigned to each region. The values in registers 41, 42 provide offsets within that region that are controlled for access by each of the CPUs. Other schemes may be used as well. It is also to be noted that registers are described herein, such as control registers 33. However, it is to be noted that storage devices, other than registers, may be used in other embodiments to provide the storage functionality.

Furthermore, in some instances, certain locations in memory may be regarded as shared space, where that shared space is accessible by both CPUs. FIG. 5 shows memory space mapping 55, where region 56 is set for CPU1, region 56 for CPU2 and region 57 for CPU1. Region 58 is within range of both regions 56 and 57 and, therefore, regarded as shared space. That is, region 58 may be accessed by both CPU1 and CPU2. Note that because of separate read/write access controls are available for the regions, region 56 may be established as a CPU2 read only region, so that shared space 58 may be set up as a read/write space for CPU1, but a read only access for CPU2. The memory mappings shown in FIGS. 4 and 5 are examples only and many other memory mapping schemes may be implemented to control the access rights of each CPU into memory 24.

Referring again to FIG. 2, when control registers 33 are comprised of a plurality of register sets 40 of FIG. 3, the memory may be mapped into different regions, in which the registers also define which CPU (or CPUs, in case of shared space) may access a particular region and the type (read and/or write) of access permitted. As noted above, during initialization, ACM 25 sets the control registers 33. Since ACM 25 is a separate and dedicated processor, the defined values that are loaded into registers 33 provide secure access control within SC 23 for each CPU to access memory 24. OS or other programs that may be breached through CPU2 are not used in managing the loading of the values into control registers 33. Matter of fact, only ACM 25 is permitted to load the values into control registers 33.

Furthermore, in one embodiment, a dedicated ACM port 34 is used to couple ACM 25 to control registers 33. That is, ACM 25 is coupled to control registers 33 through dedicated port 34, so that no other component may access control registers 33 to program control registers 33. Thus, only ACM 25 has the capability of programming the values into control registers 33.

Then, in the example operation, when the two CPUs are to be separated into the two afore-mentioned Privileged and Restricted Zones for sandbox mode operation, control registers 33 are accessed for an access check by access check module 32 to determine if the particular processor has rights to access the address location for the type of access attempted. For example, when CPU2 requests an access to a location in memory, cache control module 31 provides the address tag to determine a hit in a cache line of data bank 30. At the same time, the address is checked in the control registers to determine if CPU2 has access rights to a region that particular location resides in and for the type of access (read/write) attempted. If the access rights check does not confirm a permission to access that location, then the access attempt is not permitted. An error signal, exception or some other indication signaling an unauthorized access attempt is made known to the system. If the address location fits within a range of addresses permitted for that access, then SC 30 makes the access to memory, provided the type of access is also permitted.

A similar scenario may apply to an access by CPU1 as well. In one embodiment, CPU1 and CPU2 are both segregated into separate and distinct zones when in a sandboxing mode. In another embodiment, the trusted CPU1 is set up having its own segregated regions of memory and also given access rights over some or all address ranges of memory mapped portions of CPU2. In some embodiments, it may be desirable to turn off the sandbox mode, which separates the zones. In that instance, the system turns off the sandbox mode and the control registers 33 are ignored. The two CPUs then would operate normally as a two CPU processing machine without implementing the access check control as described above with the use of control registers 33.

In certain situations or systems, there may be an instance when data is not cached. In order to provide for sandbox protection to uncached data, in an alternative embodiment, a second access check is provided somewhere in a pathway to other portions of the system. For example, with system 20 of FIG. 2, a second access check is provided at interface 35 that couples to other parts of the system (e.g. memory 24). The constraints imposed by control registers 33 are used to provide an equivalent access check at interface 35. Accordingly, control registers 33 or access check module 32 may be coupled to interface 35 so that interface 35 has the ability to validate permissions for uncached Read and/or Write operations to locations beyond interface 35. Note that this scheme may be implemented in BIU 19 of FIG. 1, as well.

FIG. 6 (shown on two sheets as FIGS. 6A and 6B) shows a more detailed embodiment of system 20 of FIG. 2. FIG. 6 shows an integrated circuit chip that includes processors 21, 22 and SC 23 on a single chip. Although not shown, in one embodiment, ACM 25 may be included on the same chip as well. Likewise, in one embodiment, memory 24 may also be included on chip. In FIG. 6, processor 21, as well as processor 22, may each be a single processor (or processor core). However, in another embodiment, each processor is actually comprised of multiple processors or processing cores. For example, in one embodiment for implementing the system of FIG. 6 (as well as systems of FIG. 1 and FIG. 2), a quad-core processor is used. When placed into the sandbox mode, two cores are allocated to the Privileged Zone and two cores to the Restricted Zone. The two Privileged Zone processors operate equivalently to the afore-described operation of CPU1 and the two Restricted Zone processors operate equivalently to the afore-mentioned CPU2. In one embodiment, different threads are run on each processor, so that a quad-core processor is capable of executing four threads, two in each zone. Other combinations are possible when practicing other embodiments of the invention.

Each processing core includes a processor execution pipeline 60, instruction cache 61, data cache 62 and processor interface 63. Note that “A” is appended to the item number for those items associated with the Privileged Zone and “B” is appended to the item number for those items associated with the Restricted Zone. The instruction cache and the data cache are equivalent to the primary cache of FIG. 2. Although a variety of processors may be used, in one embodiment, MIPS 32 Instruction Set Architecture is employed. Other processor architectures, such as ARM and X-86 processor architectures, may be used in other embodiments. Further, the processor pipeline is a 12-stage pipeline, four pipeline stages are used for fetch and eight pipeline stages are used for execute. Fetch and execute operate separately. The processors are dual issue superscalar processors which simultaneously execute instructions from two program threads in the pipeline 60.

SC 23 includes an interface 64A to couple to respective core interface 63A in the Privileged Zone and interface 64B to couple to respective core interface 63B in the Restricted Zone. Note that one interface 64 is associated with a given core. Thus, four interfaces 64 are used for a quad core system. SC data bank 30 is a multi-banked cache that is coupled to interfaces 64 via data switch 77 for transfer of data between the data banks and the CPUs. SC data bank 30 is also coupled to interface 35 via data switch 77 for transfer of data between the data banks and memory 24. In the example, two interfaces 35 are shown coupled to two separate memory buses, noted as SCB Memory Bus0 and SCB Memory Bus1. Two buses are used in FIG. 6 to respectively couple data banks 30 to two different memory banks. In those embodiments where only one memory bank is employed for memory 24, there would only be one SCB Memory Bus. Likewise, other embodiments may use more than two buses to couple respectively to more than two memory banks.

ACM port 34 is illustrated in the lower right corner and is used as a dedicated port to couple to ACM 25. As shown, ACM port 34 is coupled to control registers 33, so that ACM 25 may program the set of registers of the control registers 33. The access check module 32 is coupled to control registers 33 for providing the access check as described earlier above.

Cache control module 31 of FIG. 2 is represented by a plurality of functional modules 70-77. A cache access arbitrate and issue module 70 receives an access request from one of the processor cores and issues a request to a SC tag module 72 for a tag address comparison in association with a SC directory caching info module 73 to determine a cache line hit. A least-recently-used (LRU) replacement module 71 is used for age determination in filling a SC data bank when a cache fill is required. A SC access controller array sequencer 75 is used for controlling the data bank access for reads and writes and a system request processing pipeline module 74 provides data path control, as well as cache coherency. A replay queue module 76 provides for replays when needed.

As noted above, when an access request is received at module 70, in parallel with the tag checking, access check module 32 performs the access rights check by accessing control registers 33 to determine if the attempted access request from a particular processor is within the authorized address range for that processor. A type (read/write) check is also performed to determine if that particular type of access is granted for that processor for the specified address. When the access rights check passes, access check module authorizes the access. If the check fails, an indication is sent to module 74 and module 74 ensures that data switch 77 is not activated to perform the data transfer through data switch 77.

It is to be noted that FIG. 6 is but one implementation of a cache memory and that other cache circuitry may be employed. For example, in one embodiment, 8-way set-associated cache is used, with either 256 sets of 8-lines each or 512 sets of 8 line each. The cache and the processors may have different modes of operation, such as user mode, supervisor mode and kernel mode. When in the sandbox mode, the processors are segregated into at least two sandboxed zones as described above, at which time the control registers 33 are made active to access check module 32 to perform the access rights check.

As noted above in reference to FIG. 2, in certain situations or systems, there may be an instance when data is not cached. In order to provide for sandbox protection to uncached data, in an alternative embodiment, a second access check is provided somewhere in a pathway to other portions of the system. For example, with the example system of FIG. 6, a second access check is provided in the data path. Thus, as noted with the alternative embodiment of FIG. 2, a second access check may be provided at interface(s) 35 that couples to other parts of the system (e.g. memory). Alternatively, the access check may be provided within data switch 77, or some other component that resides in the data path. The constraints imposed by control registers 33 are used to provide an equivalent access check at this second access check point. Accordingly, control registers 33 or access check module 32 may be coupled to interface 35 (or some other component providing the second access check) so that this second check has the ability to validate permissions for uncached Read and/or Write operations to locations beyond interface(s) 35. Thus, in instances when uncached accesses are possible, this second access check ensures that uncached data accesses do not circumvent the access protection.

In addition to the access check to control bus access in a multi-processor system, where some of the processors share resources, the ownership of these resources should be tracked and restricted to match the access separation. A data asset, such as a cache line or a transient entry in a write buffer may be present in the system as a result of allowed bus accesses from multiple processors. Each asset should be systematically tracked for ownership as it traverses the system. Without hardware-managed ownership tracking, there is no secure way to separate the access rights to the data items traversing the system.

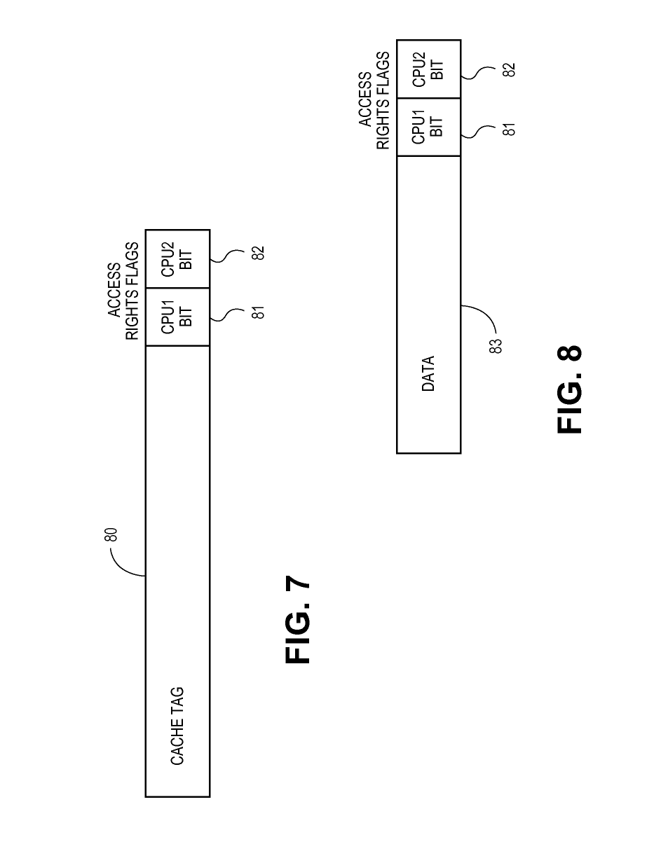

In order to ensure data ownership and to track ownership throughout the processor-SC level of the hierarchy, ownership flags are attached to a data asset and travels with the data asset at the upper hierarchy level of the processor and the secondary cache. Accordingly, as shown in FIG. 7, access rights flags are attached to a data asset. The data asset in one embodiment is defined as a cache line. Accordingly, when a cache address tag is generated when acquired into SC 23, a flag is set indicating which processor owns the cache line. Typically, when a particular processor fills a cache line, SC 23 not only fills the data bank, but SC 23 also sets the access rights flag associated with that processor.

In FIG. 7, two access rights flag bits 81, 82 are attached to a cache tag 80 that pertains to a cache line. Using the two processor example of CPU1 and CPU2, a corresponding flag bit is set based on which CPU had initial ownership (e.g. filling the cache line). For example, if CPU1 filled the cache line, when the tag is generated corresponding to the cache line, flag bit 81 is set indicating that asset is owned by CPU1. It is to be noted that additional access rights flag bits may be used with additional processors and/or additional sandboxed zones.

In FIG. 7, the access rights flag bits 81, 82 are attached with cache tag 80, since the tag is associated with the data asset being tracked, which is the cache line in the example. However, in other embodiments, the access rights flags need not be limited to association with a tag. Thus, as shown in FIG. 8, access rights flags may be attached to data itself that is to be tracked. Accordingly, data 83 may have attached to it access rights flags 81, 82 to track which processor has ownership of the data. Using the earlier example in which flag bit 81 is set, the same bit is set for data 83 to indicate ownership by CPU1. In this manner, the access rights flags may be used in various association with a data asset to designate ownership of the data asset. Therefore, flag(s) may be set when the asset enters a subsystem to track ownership of the asset as the data travels the subsystem and cleared when such tracking is no longer needed.

With the particular operation of SC 23, the access rights flags are attached to the tag and a corresponding flag bit is set based on which processor filled the cache line. Since SC 23 caches both CPU1 and CPU2 entries, the access rights flags determine which CPU has ownership to the cached data corresponding to the cache line. When data associated with the cache line travels within the system at the processor-SC hierarchy level, such as in the pipeline stages of SC 23, the flags are also present. When a processor requests access to a particular asset, the associated access rights flags are checked to determine ownership. If the data item has its flag set corresponding to the requesting processor, the access to the data item is granted. Otherwise, the attempt to access the data item fails. Optionally, accesses attempting to violate another CPU's data are reported to the system and/or to the CPU having ownership of the data item.

Accordingly, ownership tracking is provided within SC 23 by use of access rights flag bits that are attached to a data item or asset. In one embodiment, the data item is a tag associated with a cache line. By associating a hard bit with the data item, ownership of that data item may be tracked within SC 23, so that unauthorized access to the data item by another processor is prevented. Tracking the ownership throughout SC 23 allows for secure separation of accesses without the involvement of the OS and/or application software. Furthermore, it is to be noted that the ownership flag usage need not be limited to SC 23. The ownership flags may be used at other levels than the Secondary Cache. The technique may be used with other sub-systems as well.

Furthermore, it is to be noted that the access rights flag bits to indicate ownership are in addition to any cache coherency protocol, such as MSI, MESI, MOSI, MOESI, etc., protocols used to maintain cache coherency. Accordingly, SC may implement the access rights flag bits in addition to one of the cache coherency protocols and the access rights flag bits should not be confused with the ownership bit assigned for maintaining coherency.

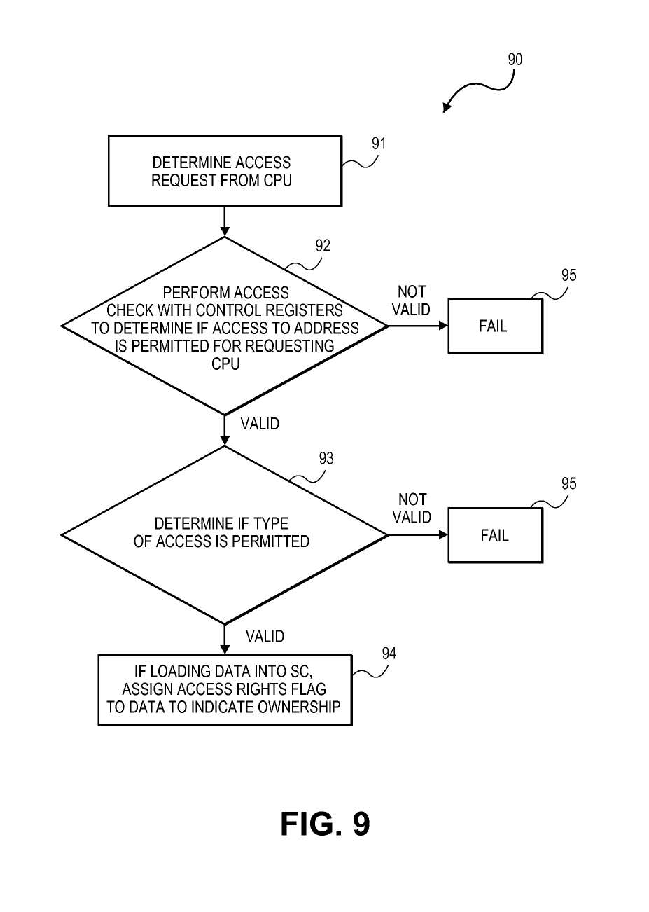

FIG. 9 illustrates a method 90 that may be used when placing two or more processors in a sandbox mode to separate or segregate zones and in which data is brought from memory to fill a cache line. When a CPU requests access to a SC that supports the processors, a determination is made regarding the access request from the CPU (block 91). The access request is evaluated to determine if the address associated with a bus access to memory is within an address range stored in the control registers (block 92). If the request is within a permitted range for that processor, the type of access is checked to determine if that type is permitted (block 93). Otherwise, the access fails (block 95). If permitted, then the memory may be accessed and data loaded into the SC and ownership is indicated for that data by setting the appropriate access right flag bit (block 94).

Thus, a scheme to maintain bus access control and to track data assets in a cache memory utilized by multiple processing modules, processors or processor cores to obtain secure separation between separated processing zones is described. The dedicated hardware protection provided in the cache memory is less susceptible to access by other programs running on the system, such as an OS or applications software.

It is further to be noted that there are many applications for implementing various embodiments of the invention. As noted, one environment is the implementation of the invention for sandbox operations when more than one processing modules, processors (or sets of processors) or cores are to be separated or segregated into different zones. In one implementation, one zone is a Privileged Zone, while the second is a Restricted Zone. Examples of this usage are in set-top box functionality, whether provided in a separate set-top box or integrated into a television unit, or some other renderer. In one application, the Privileged Zone would run the functions set by a cable or satellite provider for receiving content, such as television channels, paid content, etc. The Restricted Zone may be utilized to run user or public based applications or connect to a public communication link, such as web browsing on the Internet via an Internet pathway, and/or providing wireless (e.g. Wi-Fi, WiMax, hotspot) communication access. Other examples abound.

Likewise, another example is the use of an embodiment of the invention in mobile devices in which the Privileged Zone is used to run mobile communications that connect to a wireless provider of the device, such as a cellular telephone provider, while the Restricted Zone may be used to run user accessed applications on the handheld device and/or provide connection to a wireless router or local hotspot for accessing the Internet. Similarly, other examples include, gaming consoles, personal computers (PCs), notebook or laptop computers, tablet computers, as well as others.

As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributed (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The embodiments of the invention have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The invention has also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” is used in the description of the various embodiments of the present invention. A module includes a processing module, a functional block, hardware, and/or software stored on memory for performing one or more functions as may be described herein. Note that, if the module is implemented via hardware, the hardware may operate independently and/or in conjunction software and/or firmware. As used herein, a module may contain one or more sub-modules, each of which may be one or more modules.

While particular combinations of various functions and features of the invention have been expressly described herein, other combinations of these features and functions are likewise possible. The invention is not limited by the particular examples disclosed herein and expressly incorporates these other combinations.

We claim:

1. An apparatus comprising:
a first processing module to operate on a first set of instructions;
a second processing module to operate on a second set of instructions, separate from the first set of instructions, wherein the second processing module is to be functionally segregated from the first processing module to prevent the second processing module from executing instructions to access an address assigned solely to the first set of instructions of the first processing module;
a cache coupled to the first and second processing modules to provide caching of data for the first and second processing modules;
a control storage device coupled to receive programming from a control hardware to set address ranges accessible by the first processing module and address ranges accessible by the second processing module, wherein the control hardware is a separate hardware from the first and second processing modules; and
control circuitry coupled to the first processing module, the second processing module, the cache and the control storage device to provide an access check when address access is initiated by the first and second processing modules, wherein when the first processing module attempts to access an address space outside of address ranges set for the first processing module in the control storage device or when the second processing module attempts to access an address space outside of address ranges set for the second processing module, an error indication is generated to prevent the cache from accessing outside of permitted address ranges.

2. The apparatus of claim 1, wherein the first processing module is a secure processing module to execute the first set of instructions free from non-secure access by the second processing module.

3. The apparatus of claim 2, wherein the first processing module is to execute instructions relating to a set-top box and the second processing module is to execute instructions relating to a user application.

4. The apparatus of claim 2, wherein the first processing module is to execute instructions relating to a set-top box and the second processing module is to execute instructions relating to accessing a public communication link.

5. The apparatus of claim 2, wherein the first processing module is to execute instructions relating to a set-top box and the second processing module is to execute instructions relating to accessing an Internet pathway.

6. The apparatus of claim 2, wherein the first processing module is to execute instructions relating to a mobile device and the second processing module is to execute instructions relating to a user application running on the mobile device.

7. The apparatus of claim 2, wherein the first processing module is to execute instructions relating to a mobile device and the second processing module is to execute instructions relating to a user application running on the mobile device that accesses an Internet pathway.

8. The apparatus of claim 1, further including a dedicated port coupled to the control storage device, wherein the dedicated port is used only to couple to the control hardware for programming the control storage device.

9. An apparatus comprising:
a first processor to operate on a first set of instructions, the first processor including a primary cache;
a second processor to operate on a second set of instructions, separate from the first set of instructions, wherein the second processor to be functionally segregated from the first processor to prevent the second processor from executing instructions to access an address assigned solely to the first processor, the second processor including a primary cache, and in which the first processor is a secure processor to execute secure instructions and the second processor is a non-secure processor to execute instructions that are not secure; and
a secondary cache coupled to the first and second processors to provide caching of data for the first and second processors, the secondary cache being an inclusive cache of the primary cache included in the first processor and the primary cache included in the second processor, the secondary cache further including:
a cache data bank to store cached data;
a set of control registers to set address ranges accessible by the first processor and address ranges accessible by the second processor;
cache control circuitry coupled to the first processor and the second processor to receive an access request from one of the first or second processors and to determine the access request based on an address tag;
access check circuitry coupled to the cache control circuitry and the control registers to provide an access check by checking to determine if an access address tag of the access request is within the address ranges set for the processor requesting the access request and to permit the cache control circuitry to access the cache data bank when the access request is within the address ranges set for the processor requesting the access and to generate an error indication to prevent the cache control circuitry from permitting access to the secondary cache by the processor requesting the access when the access check fails.

10. The apparatus of claim 9, further including a control processor to program the set of control registers, wherein the control processor is a separate hardware processor from the first and second processors.

11. The apparatus of claim 10, wherein the secondary cache further includes a dedicated port to interface the control processor to the set of control registers.

12. The apparatus of claim 11, wherein the first processor, the second processor, the control processor and the secondary cache are all integrated on an integrated circuit chip.

13. The apparatus of claim 12, wherein the secondary cache further includes a bus interface to interface the secondary cache to a memory.

14. The apparatus of claim 12, wherein the first processor comprises multiple processor cores and the second processor comprises multiple processing cores.

15. The apparatus of claim 12, wherein the first processor is to execute instructions relating to a set-top box and the second processor is to execute instructions relating to a user application.

16. The apparatus of claim 12, wherein the first processor is to execute instructions relating to a mobile device and the second processor is to execute instructions relating to a user application running on the mobile device.

17. A method comprising:
storing, in a set of control registers present in a secondary cache, a set of address ranges accessible by a first processor and address ranges accessible by a second processor, wherein the first processor operates on a first set of instructions and the second processor operates on a second set of instructions, separate from the first set of instructions, and wherein the second processor is functionally segregated from the first processor to prevent the second processor from executing instructions to access an address assigned solely to the first processor, in which the first processor includes a primary cache and the second processor also includes a primary cache;
generating an access request from one of the first or second processors in which the access request generates an address tag to hit in the secondary cache;
checking the address ranges in the set of control registers to determine if an address of the access request from a requesting processor of the one of the first or second processors falls with a permitted address range stored in the control registers for the requesting processor; and
permitting the requesting processor to complete the access request in the secondary cache when the address of the access request from the requesting processor falls within the permitted address range stored in the control registers for the requesting processor, but not permitting the requesting processor to complete the access request in the secondary cache when the address of the access request from the requesting processor does not fall within the permitted address range stored in the control registers for the requesting processor.

18. The method of claim 17, further comprising programming the set of address ranges in the control registers by using a control hardware, in which the control hardware is a separate processing hardware from the first and second processors.

19. The method of claim 18, further comprising coupling the control hardware to the control registers through a dedicated port.

20. The method of claim 19, further comprising segregating a secure zone of the first processor from a non-secure zone of the second processor by sandboxing the second processor by controlling the second processor access of the secondary cache via access controls implemented via the control registers.
